(19) United States
(12) Patent Application Publication
(10) Pub. No.: US 2003/0120641 A1
(43) Pub. Date: Jun. 26, 2003

(54) Method and apparatus for dynamic database creation and interactive analysis

(76) Inventor: Stephen Pelletier, (US)

Correspondence Address: FATTAIL, INC., Suite 209, 20969 VENTURA BLVD, WOODLAND HILLS, CA, 91364, US

(21) Appl. No.: 10/300,123

(22) Filed: Nov. 19, 2002

Related U.S. Application Data
(60) Provisional application No. 60/331,901, filed on Nov. 19, 2001.

(51) Int. Cl. G06F 7/00

(52) U.S. Cl. 707/3

(57) ABSTRACT

A method and system are provided for 1) dynamically building a relational database (DB), also known as the “Dynamic Data Model” (DDM), 2) defining and capturing “user defined attributes” (UDAs) and populating the DB with these values, and 3)querying a DB of UDAs dynamically by interacting with the results of the queries to refine and improve the query. UDAs define specific properties or characteristics of a data element (e.g., HTML is an attribute value for the Format of an Advertisement or Media, Software is an attribute value for the Product Category). UDAs allow the user to categorize and compare things that they were unable to categorize and compare before, thereby providing a more robust way to learn from historical experience.

Once attributes are defined and captured (selected), the user utilizes the interactive querying process to determine which UDA(s) have had the most impact on the measured result. For example, in advertising, the user can compare click-through rates or conversion rates (e.g., email registrations or sales) assuming different creative and placement attributes, thereby providing them with insight on how to formulate the next ad campaign.

### CROSS-REFERENCE TO RELATED APPLICATIONS

Embodiments of the present invention relate to U.S. Provisional Application Serial No. 60/331,901, filed Nov. 19, 2001, entitled “Method and Apparatus for Dynamic Database Creation and Interactive Analysis,” which is hereby incorporated by reference herein and is a basis for a claim of priority.

### BACKGROUND OF THE INVENTION

1. Field of the Invention

This invention relates generally to databases, and more particularly to advertising data.

2. Description of the Related Art

DBs are used in many aspects of today's business, particularly with respect to capturing data and then using the data to measure a business result (e.g., an advertising campaign's effectiveness) and forecast future results. Using DBs for “data mining” requires that the user specify the “factors” or attributes, (and the relationships between them), that it wants to capture to measure against results.

In order to create a useful DB of this type, most companies rely on DB specialists to define the data elements and build the relational data structures. In order to add elements or relationships, a DB specialist must go directly into the database software and manually modify the DB. For example, a user might define HTML as a field related to Media Format, and later realize that they want to add another field related to Media Format, called Text. Or they might want to create an entirely new UDA called Media Frequency and assign two possible values to it, Daily and Monthly. It is desirable to manipulate the data and the relationships on-the-fly, without any direct DB interaction. The present invention accomplishes this result.

An attribute that is defined dynamically and, therefore potentially proprietary to the user's organization, is called a User Defined Attribute (UDA). The ability to create UDA's is a breakthrough with respect to any analysis because it allows the user to compare things that were previously not comparable, thereby providing an answer to “why” or “why-not” something is performing. In many vertical markets, a tendency exists to view events in isolation and as individual circumstances that have no relation to prior events. As a result, historical events cannot often be compared against one another, or if comparisons are made, they are made against only basic and singular categories. For example, in advertising, most practitioners view each ad placement as a singular event. They know (or think they know) if that ad placement is working. At most, they might be able to query their data to compare ads that were in Text Format vs. HTML Format, or some such single level query. It is desirable to be able to compare events based on single or multiple levels, (e.g., Text vs. HTML ad performance by the Day of Week that the ads were placed and the Size of the ad and the Offer in the ad). The present invention accomplishes this result.

### SUMMARY OF THE INVENTION

The ability to create new UDAs allows for new comparisons. For example, an advertiser might define a new UDA as Product Price Range, and for every ad placement, capture the selling price for the advertised product. Now this advertiser can compare all ad performance results for all products within similar price ranges (as well as many other potential UDAs).

The ability to interactively query the DB is desirable because it allows the user to make further query decisions based on the results that are displayed. For example, the user might not know, before hand, if software ads on Tuesday achieve greater results if they contain 3,4, or 5 lines of text. Using a dynamic querying model, the user can see the results for software ads on Tuesday, for each of the new choices (3,4, or 5 lines) and then select which of these to use and continue to query further if necessary.

Once the DB is defined with UDAs, the UDA values are captured into the DB. It is desirable to be able to quickly and efficiently capture this data, either during a stand-alone process or in conjunction with a process related to the workflow function. For example, in advertising, a user might want to quickly define ad placements, select the relevant UDA values, and marry this data to the ad performance results (e.g., clicks) in a streamlined process. Or they might want to define the UDA values during the normal course of their media buying process, and possibly while they are using a Company created or third-party “workflow” tool. Workflow tools describe the general set of software tools that help the user manage client, product, and order information with respect to the specific business that they operate in. In advertising, this process might include the following steps, among others:

media research

“insertion order” (IO) creation;

creative development;

ad placement

post campaign reporting

The present invention accomplishes these results and allows for fast entry or can be integrated into existing Company, or third party “workflow” process tools.

Lastly and relating to the advertising business, it is desirable to have a pre-defined set of UDAs so that the user can start capturing the data with minimal set-up to the DB. The present invention accomplishes this by pre-defining over 100 UDAs specific to the particular field or industry, e.g., advertising.

The present invention provides a method, apparatus, and computer interface to dynamically create a relational DB for data mining analysis. Furthermore, the present invention defines an advertising DB, which can be created by collecting ad campaign performance data and attributes of the ad, media, product, etc. (UDAs), and marrying these data so that the user can analyze what and why things are working. This advertising DB is then used for dynamic querying, based on single or combinations of UDAs. The present invention also provides a list of specific UDAs related to the advertisement industry.

### DETAILED DESCRIPTION OF THE PREFERRED EMBODIMENT

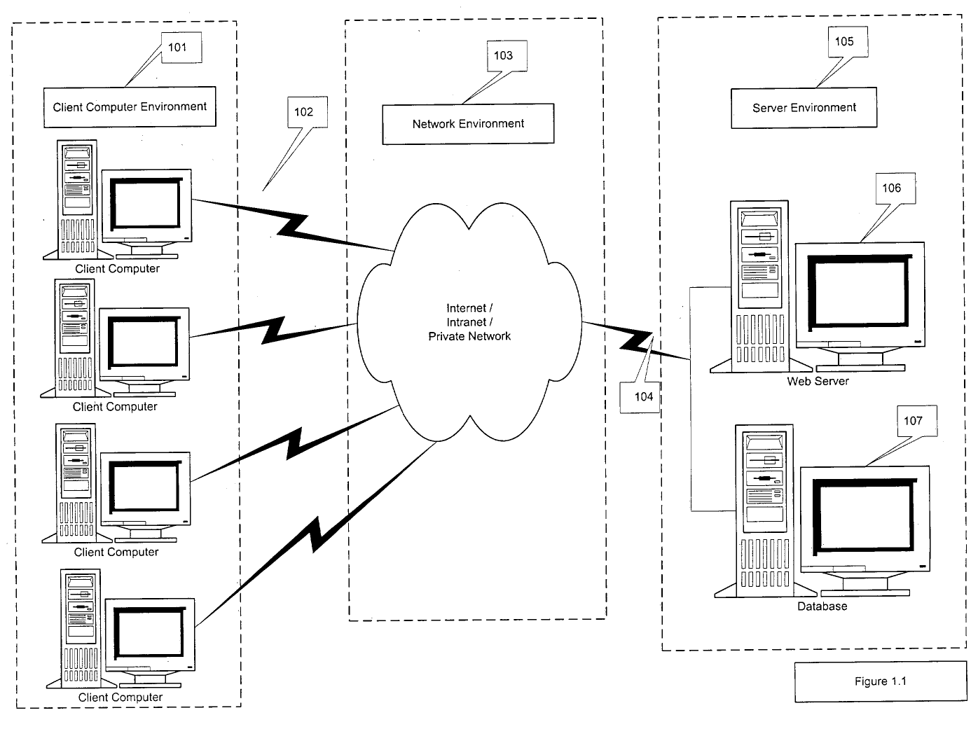

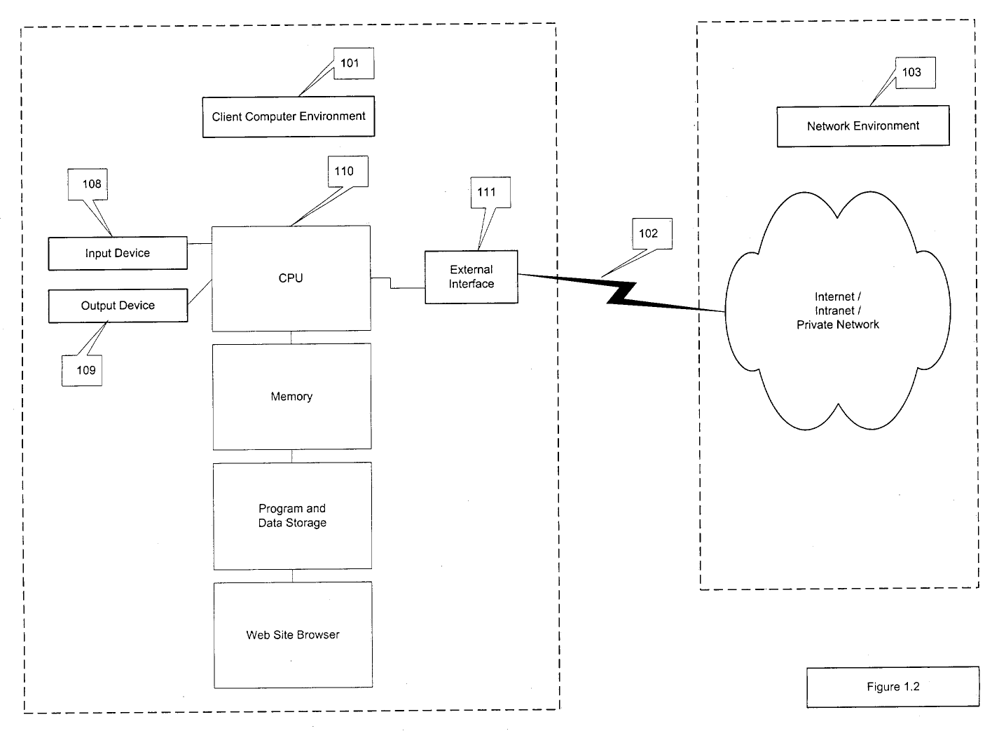

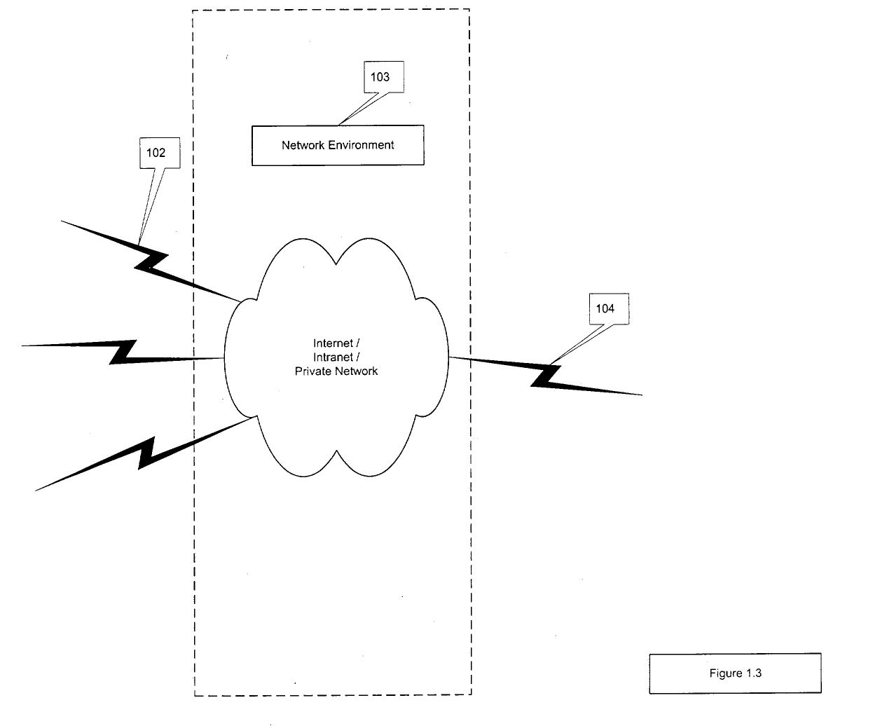

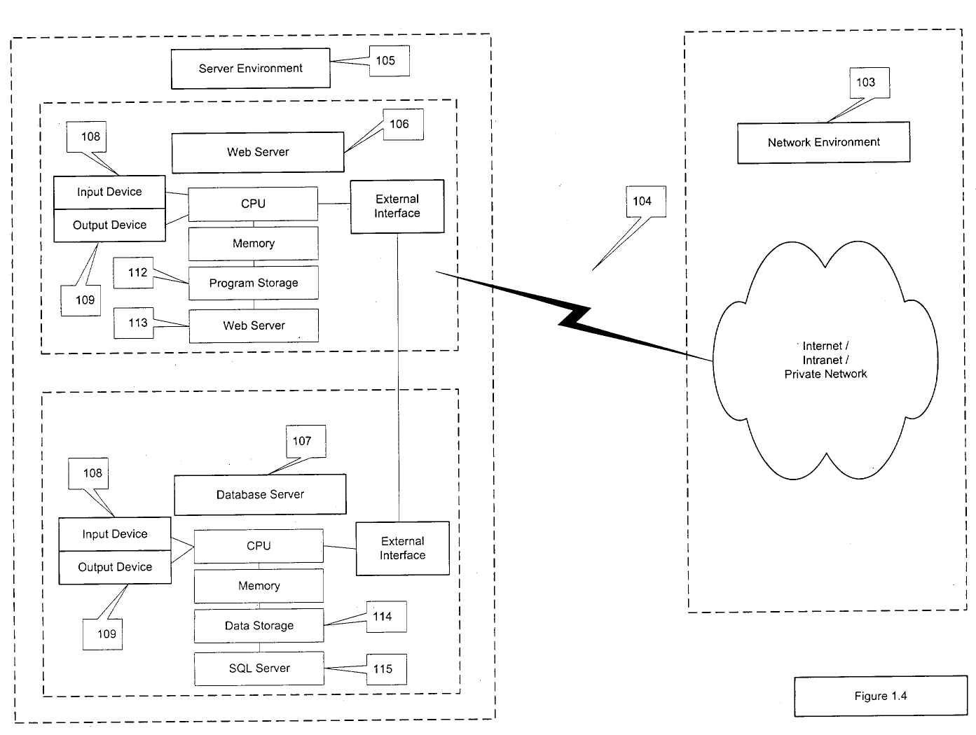

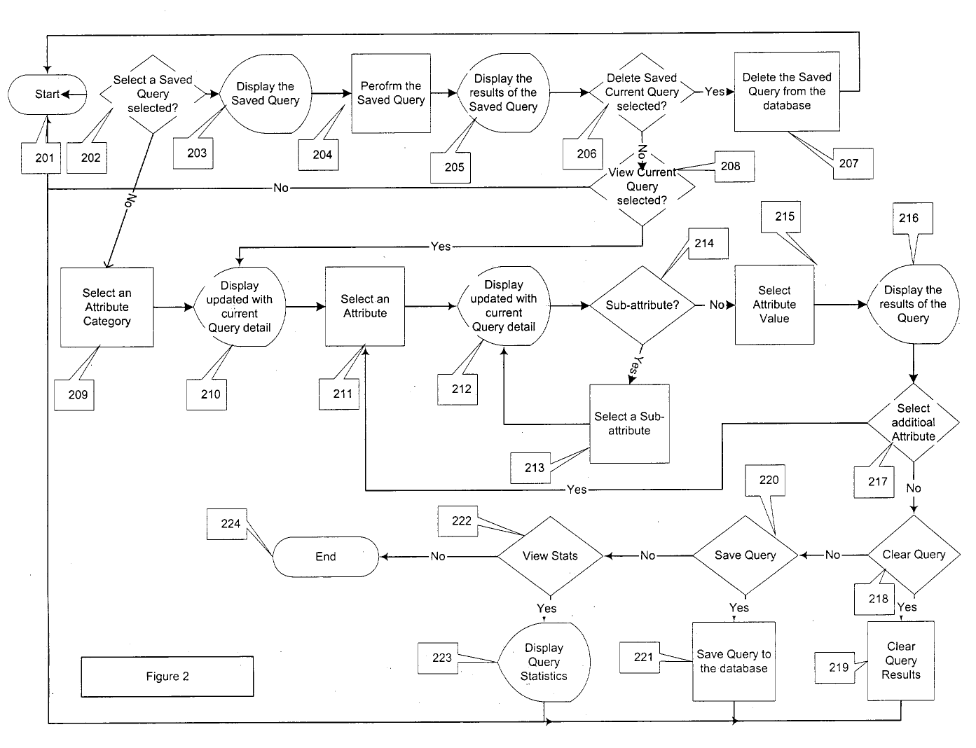

Referring to FIG. 1.1, the physical architecture of the invention is described in more detail below.

101: The client computer environment 101 represents various microcomputers which are electronically connected to the server environment 105 via a connection provided by any of the public Internet, a private network, or a corporate Intranet. The client computers communicate with the server environment using the Internet Protocol (IP). The computers make use of a software application called an Internet Browser (provided by third party manufacturers) to access the functions of the present invention.

102: The electronic connection between the client computer environment and the network environment 103 is accomplished by various means including dial-up networking, local/wide area networking, and others—each provided by third party manufacturers.

103: The network environment 103 may be any of the Public Internet, a private network, or a corporate Intranet—each provided by third parties.

104: The electronic connection between the network environment and the server environment is accomplished in a manner as described in 102, above.

105: The server environment 105 represents various microcomputers which are electronically connected to the client computer environment 101 as described in 101, above. These microcomputers execute program code and store data, all processes of which are part of the present invention.

106: The Web server 106 executes program code which generates user functionality which is the subject of the present invention.

107: The database server 107 stores data in a manner which is the subject of the present invention.

Referring to FIG. 1.2, the Client Computer environment is described in additional detail as compared to FIG. 1.1.

101: As described above.

102: As described above.

103: As described above.

108: The input device 108 includes the use of a standard microcomputer keyboard and/or mouse (or other touch pad, key pad or pointing device).

109: The output device 109 includes the use of a standard video display monitor and a printer.

110: The client computer includes several components, which are hereby described:

the CPU or central processing unit, which executes the instructions contained in the program code; the memory, including random access memory (RAM) and read only memory (ROM) which stores program instructions and data which are being processed by the CPU; the program and data storage device which permanently stores program code and data which is used by the client computer; and the Web site browser, which is an application program, provided by a third party, which provides the user with access to application software actually stored on other computers.

111: The external interface is a computer hardware device that allows the client computer to be connected to the network environment. This device may be a network interface card (NIC) or a modem, or other device appropriate to the connection being used, and is provided by a third party.

Referring to FIG. 1.3, the Network environment is described in additional detail as compared to FIG. 1.1.

102: As described above.

103: As described above.

104: As described above.

Referring to FIG. 1.4, Server environment is described in additional detail as compared to FIG. 1.1.

103: As described above.

104: As described above.

105: As described above.

106: As described above.

107: As described above.

108: As described above.

109: As described above.

112: The program storage device provides a facility for permanent storage of the program code which is the subject of the present invention.

113: The Web server is a system application software program, provided by a third party, which executes the program code which is the subject of the present invention.

114: The data storage device provides a facility for permanent storage of the data and the structure of the database which is the subject of the present invention.

115: The database server is a system application software program, provided by a third party, which stores data as per the instructions of the program code which is the subject of the present invention.

Referring to FIG. 2, the Dynamic Data Drill (3-D) is hereby described.

201: This is the starting point of the process, where the user is presented with various selection choices and options as to how they are to conduct their data analysis.

202: First, the user is allowed to select to begin a new query, or to access a query that they have previously performed and saved.

203: If the user chooses to access a saved query the system first displays a list of available queries. To accomplish this, the system queries the database and selects all and only those queries which were previously entered and saved by the user. The user selects one of the queries selected, and then the system displays the query criteria.

204: The system then performs the query on the database using those criteria. The system performs a database query, locating those records that have attribute values that are identical to the ones that are selected (from the saved query) as key fields. The records that are selected from the query have attribute values identical to all of the selected attribute values, not just one or more of these attribute values.

205: The system displays the results of the query so that the user can review those results. The query results are displayed as both an aggregation of the queried records, as well as the individual components that are included in the query. The aggregation is a summation of key field values (such as total ad impressions or clicks, in advertising) thereby allowing the comparison of similar records across the selected attribute categories.

206: At that point the user can choose to delete the saved query or continue to view the currently selected query (208).

207: If the user chooses to delete the current query, that query information is deleted from the database, and the user is returned to the starting point of the Dynamic Data Drill process (201).

208: If the user chooses to not delete the current query in step 207, the display is updated with current data from the database and the results of the query are redisplayed as described in step 205, above.

209: If the user chooses to begin a new query in step 202, the user can select an Attribute Category on which to perform the query. A list of Attribute Categories are displayed for the user to select based on the data model in the database.

210: Once an Attribute Category is selected, the display updates the appropriate attribute data based on that selection. The system perform a query that retrieves all records of all items that contain any of the attribute values associated with that attribute category, and subject to any prior query selection requirements, and displays the aggregation of these as described in 205 above. The ‘dynamic’ data drilling allows for interactive querying of the data set. Additionally, if the user chooses to view the currently selected query in step 207, the user is presented with an updated display of query results based on their currently selected query. The query results are generated in the same manner as described in item 204, above.

211: The user then selects an attribute value on which to continue to perform the query on. Once the attribute value is selected, the user can now continue to select other attribute categories as described in 209 above, and further refine the current query.

212: The system then also queries the database and retrieves any data related to the sub-attribute which was selected, and the display is updated to include that information.

213: If any sub-attributes were displayed as a result of item 211, described above, the user may elect to select one of those sub-attributes.

214: If a sub-attribute was selected, a list of attribute values is displayed. The system then performs the functions as described in item 212, above.

215: The user then either chooses another attribute category, attribute, or sub-attribute, and restarts the data evaluation process as described in item 209, above, or the user selects an attribute value as available from the currently selected attribute or sub-attribute.

216: When the attribute value is selected, the query is processed as described in item 204, above, and the results of that query are displayed for the user's evaluation.

217: At that time the user may either select additional attribute categories, attributes or sub-attributes to add to the analysis, in which case they revert to item 209 of the process, described above. Alternatively, the user may clear the query (described in 218, following); save the query (described in 220, following); or the user may view statistics relating to the current query (described in 222, following).

218: Should the user elect to clear the current query, the user selects the clear query function.

219: When the clear query function is accessed, all of the details of the current query are removed from the current display, and the list of attribute categories, attributes, sub-attributes, and attribute values are all reset to what was displayed when the Dynamic Data Drill was first accessed. At that time the user can return to item 201 of the process, described above.

220: Should the user elect to save the current query, the user selects the save query function.

221: When the save query function is accessed, the user is prompted to enter a name for the query. Once entered, the query information is saved to the database, along with the query name, so that it may be easily accessed by the user at a later time, as described in item 202, described above.

222: Should the user elect to view the statistics of the current query, the user selects the view stats function.

223: When the view stats function is accessed, the system updates the display to show the detailed statistics of the current query by retrieving details related to the current query from the database, computing the statistical values (including, but not limited to average, standard deviation, minimum, and maximum), and displaying those values which result.

224: At any time the user may elect to exit the Dynamic Data Drill application, which ends the processing of that software application.

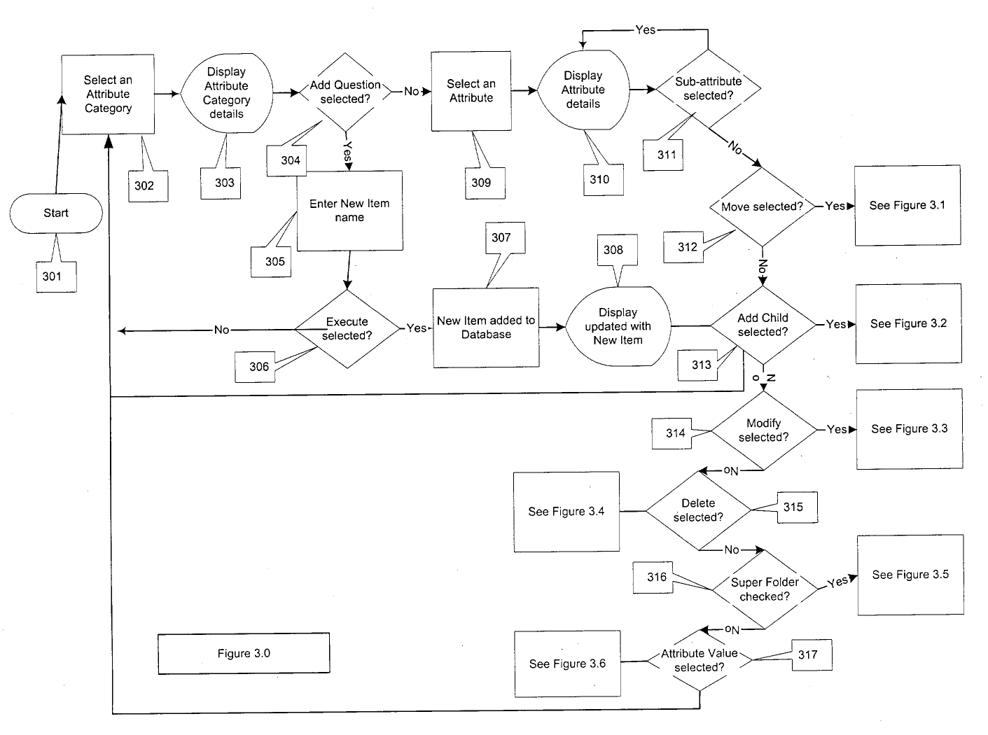

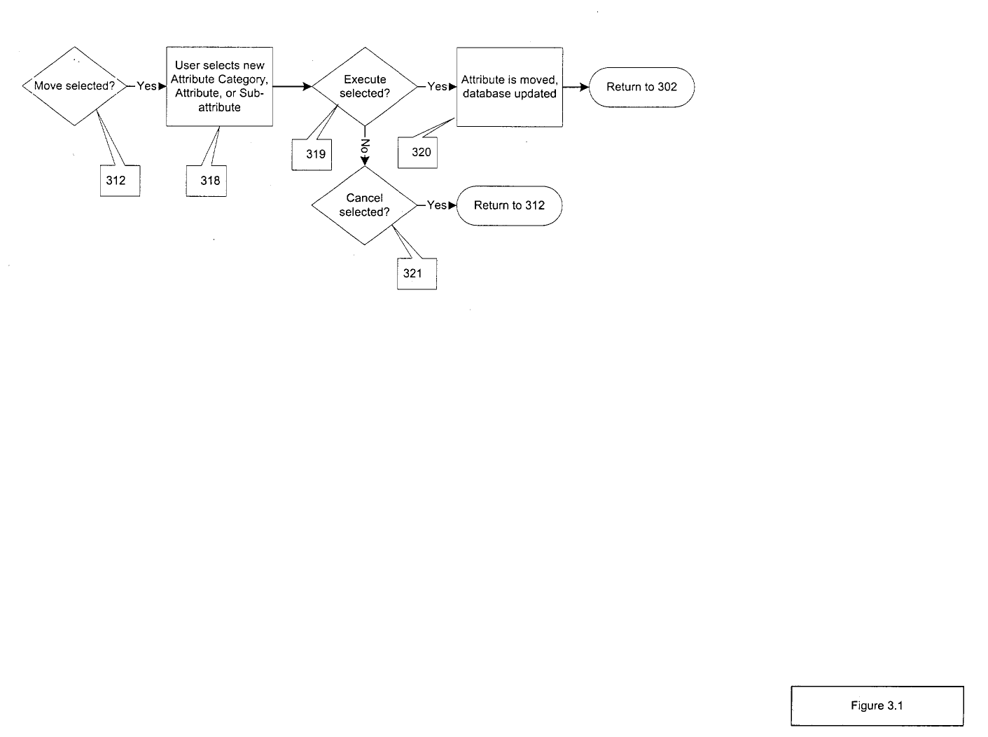

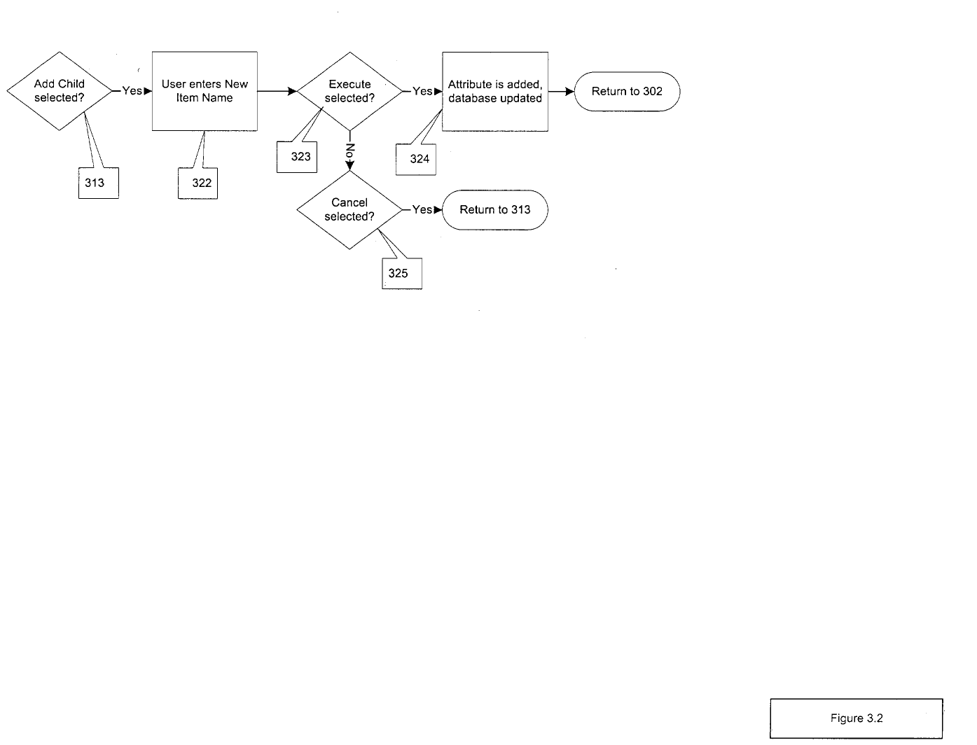

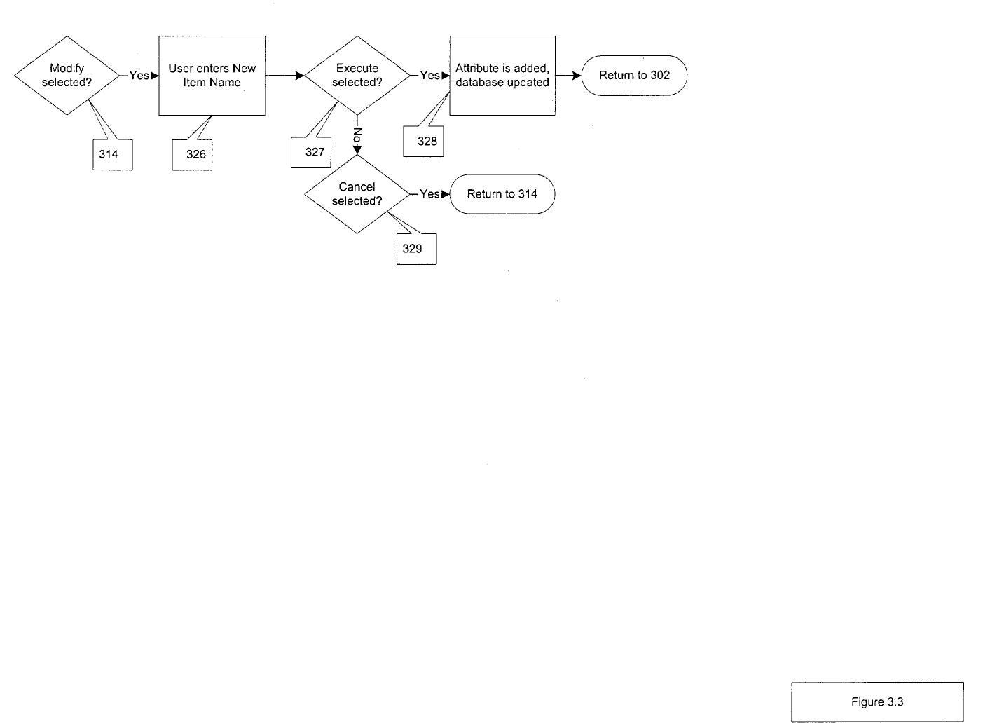

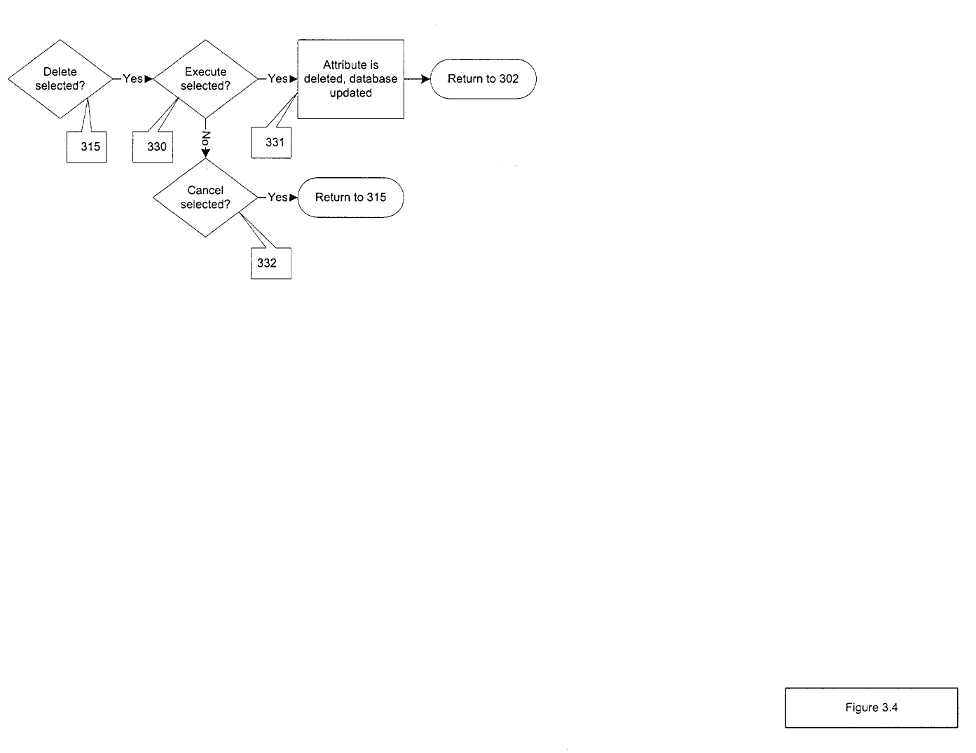

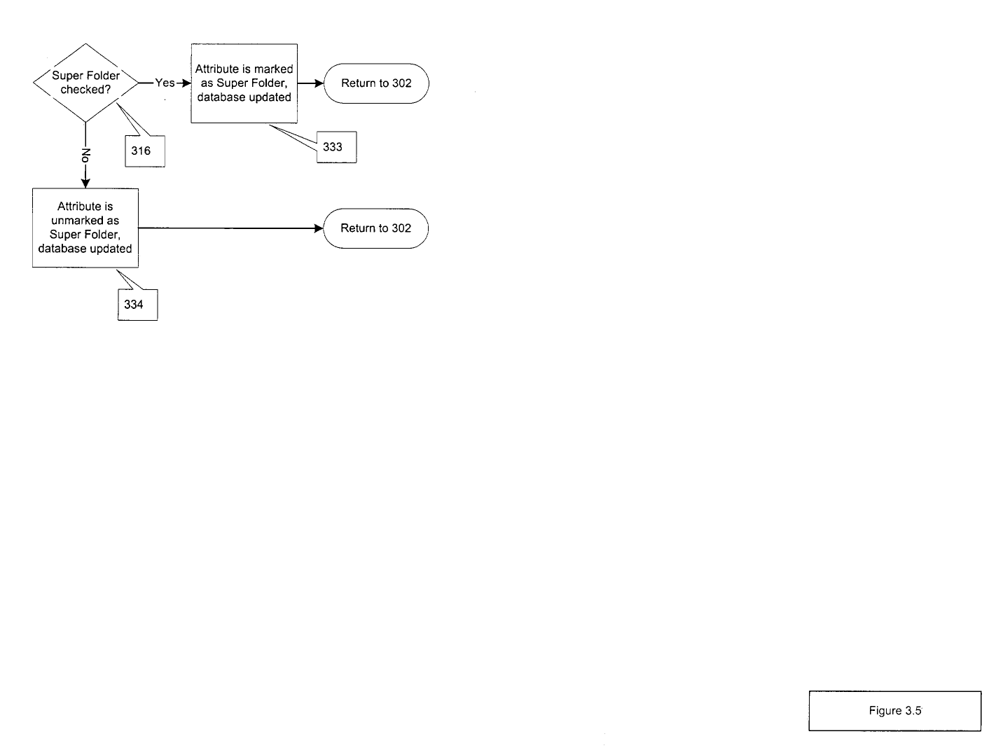

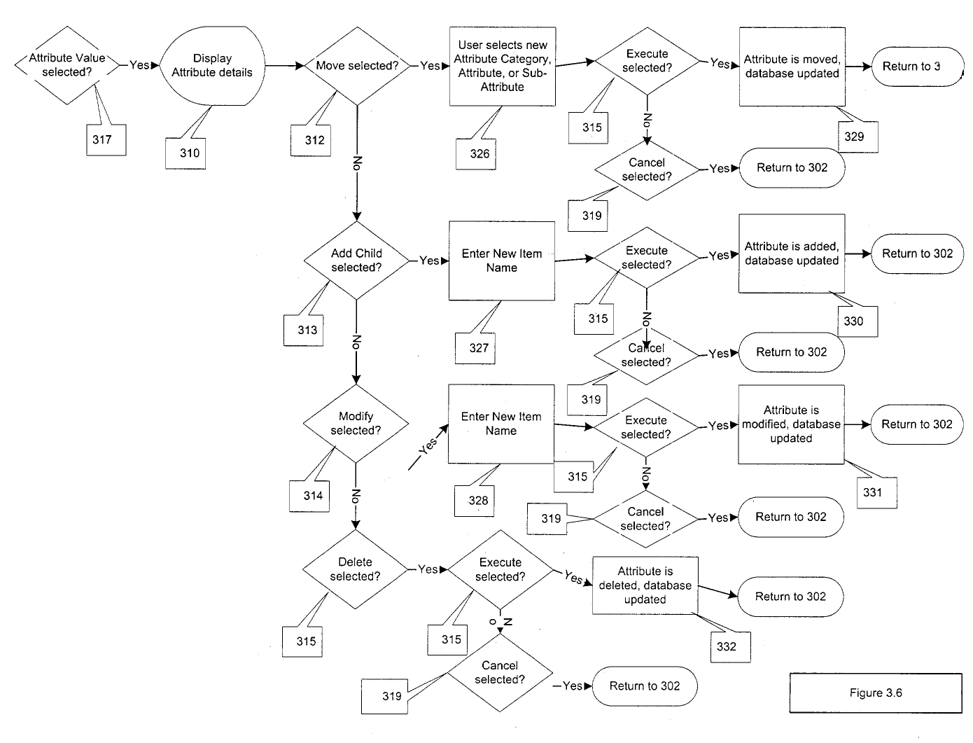

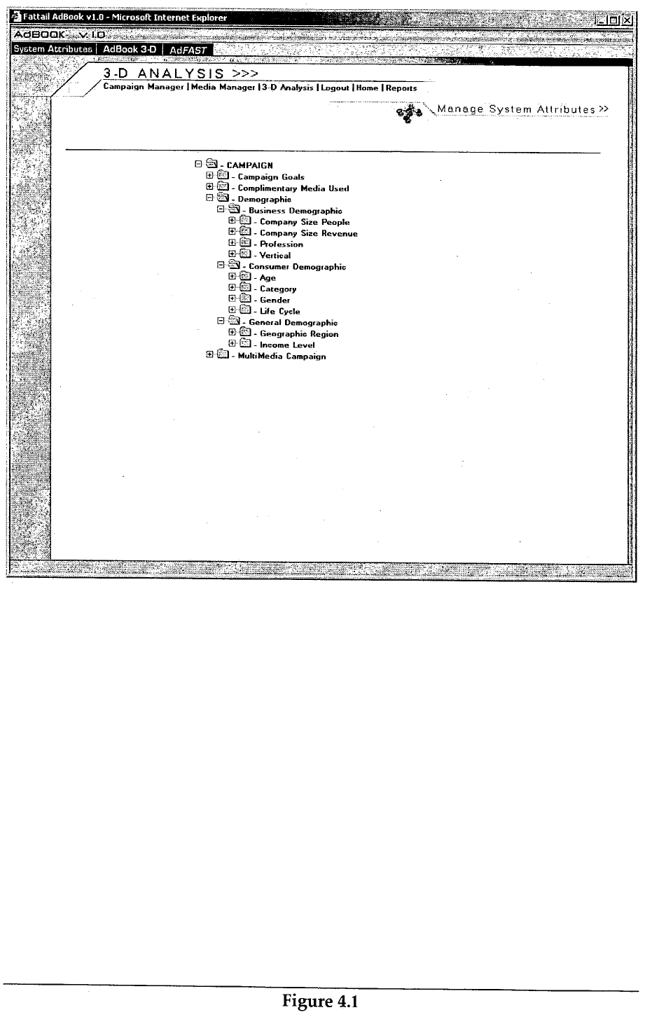

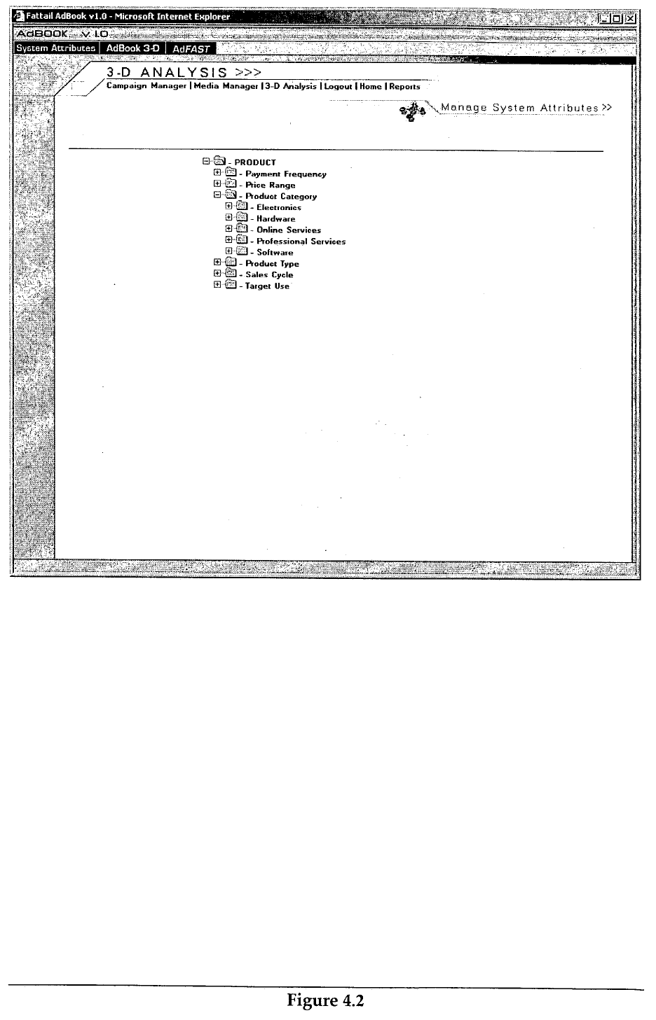

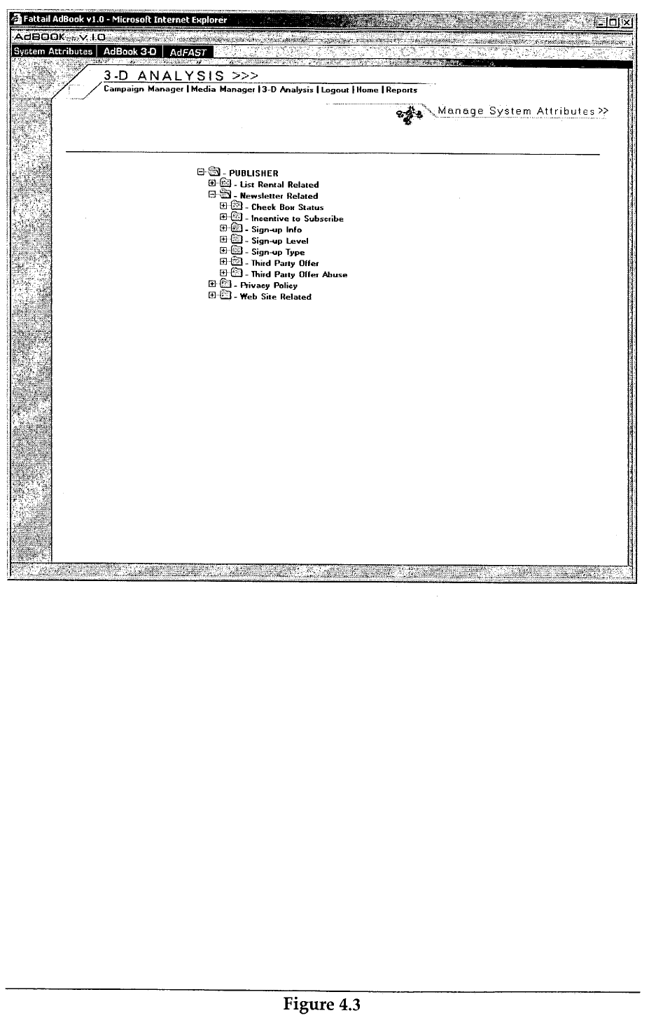

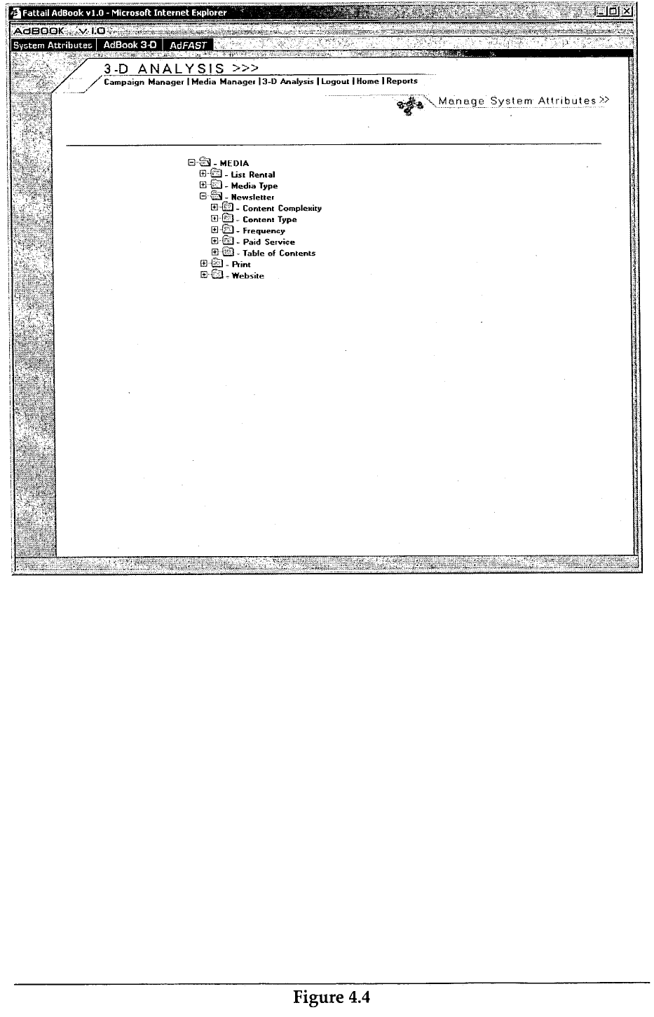

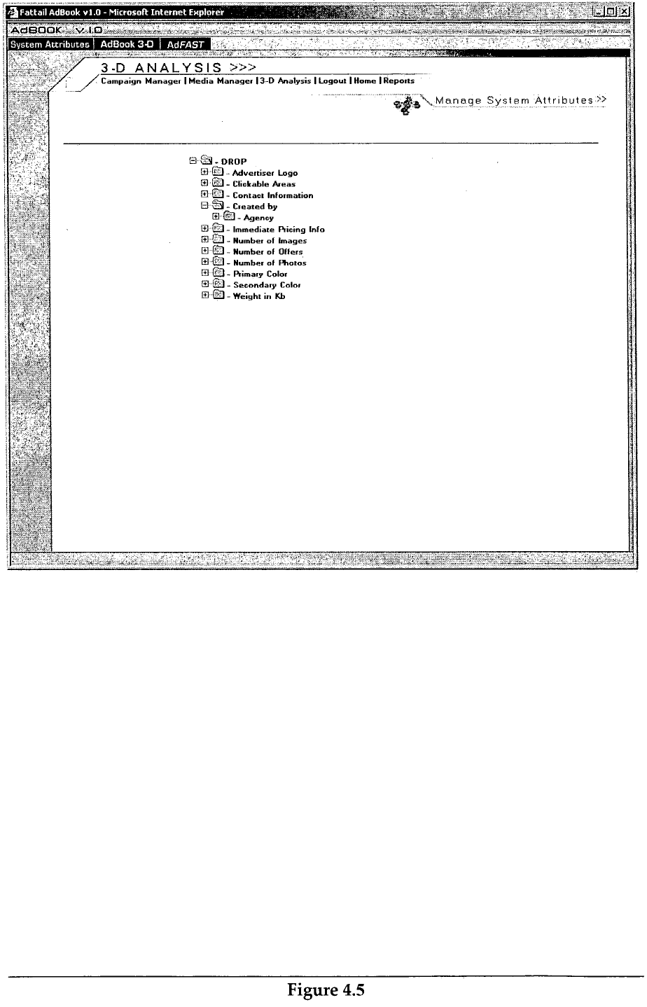

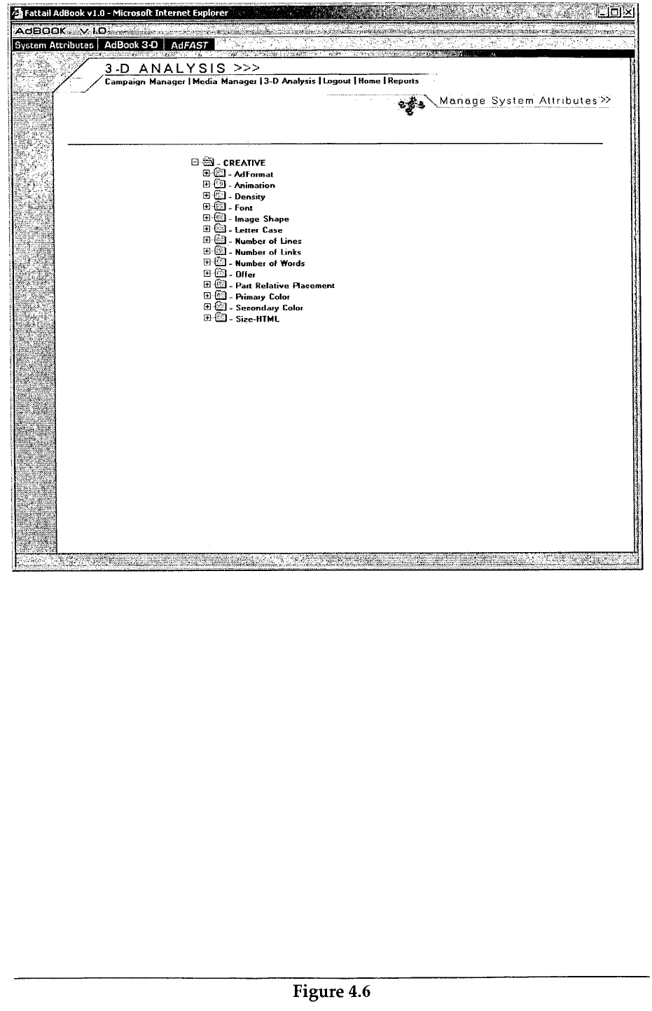

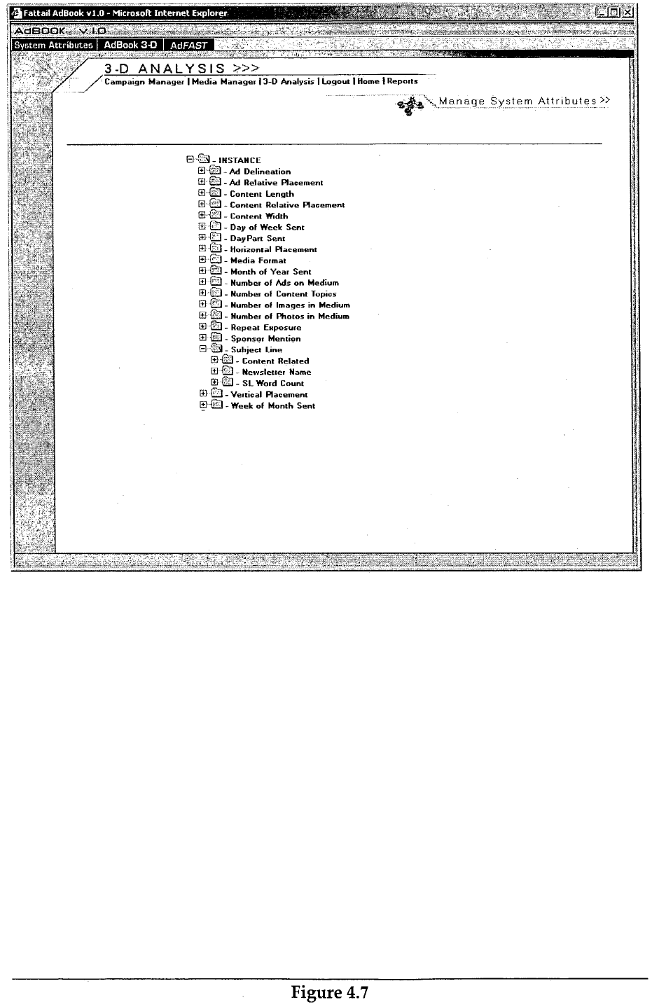

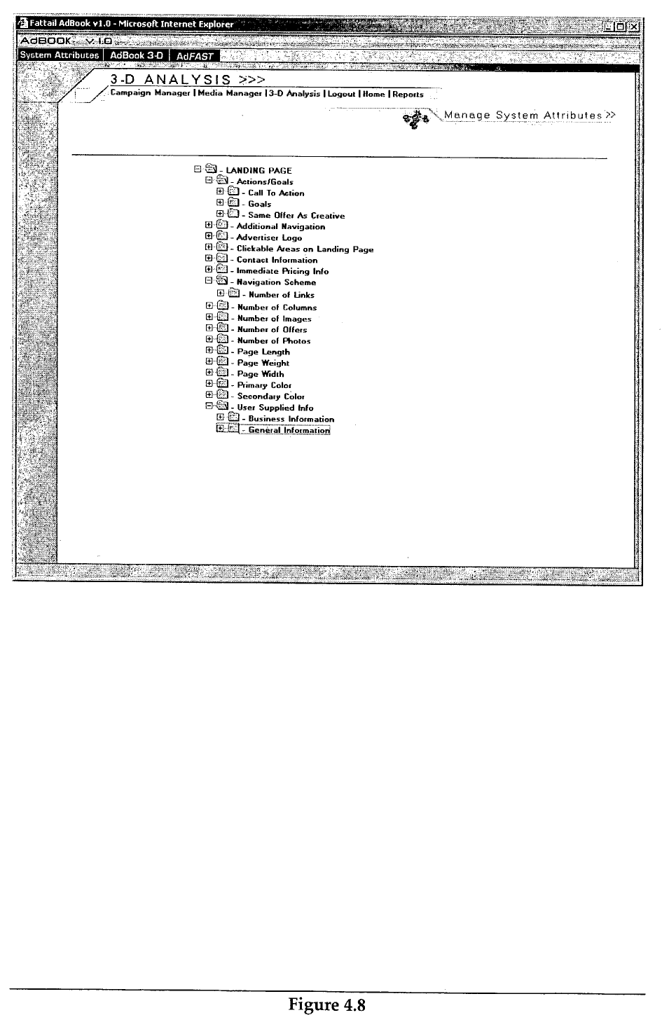

Referring to FIG. 3.0, the Attribute Category Definition process is hereby described.

301: This is the starting point of the process, where the user is presented with various selection choices and options as to how to conduct their data analysis. The display is initiated and includes a list of the attribute categories currently included in the database.

302: The user can choose any of the attribute categories displayed.

303: Once selected, the system updates the display in two areas: first, the details related to the selected category are displayed. Those details include the item name (which is the same as the attribute category); the item type; the parent item; and an indicator as to whether the attribute category is a “super folder” or not. A “super folder” is a generic term for an attribute category or value that is “superior” to attributes below it and the user wishes to be able to aggregate all of these sub attributes for display at the “super” level. An example of this in a product category could be “Software”, where the true attribute values might be the type of software (i.e., operating system, analytic package, etc.). A user creates super folders so that they can view the aggregation of all subordinate attributes as one attribute value (software) instead of or in addition to their specific values (i.e., operating systems), when performing a data query. Second, the attributes related to the selected attribute category are displayed, immediately under the attribute category which was selected.

304: The user may then select an attribute to review, or may select the add question function.

305: Should the user elect to enter a new item name, the user selects the add question function. In this case, the system displays a text entry box, titled “New Item Name” and the user enters the name of the new item. Once complete, the user selects either the execute or cancel function.

306: If the user has entered a new item name and then selects the cancel function, the system returns the user to the display of the attribute category previously selected.

307: If the user has entered a new item name and then selects the execute function, the system stores the new item into the database.

308: The system then updates the display with the new item name, and the system also returns the user to the initial display of the attribute category definition process.

309: After display of the item details for the initial attribute category selected, the user may elect to select an attribute.

310: Once selected, the system updates the display in two areas: first, the details related to the selected attribute are displayed. Those details might include the item name (which is the same as the attribute); the item type; the parent item; and an indicator as to whether the attribute is a super folder or not. Second, the sub-attributes and/or attribute values related to the selected attribute are displayed, immediately under the attribute which was selected. The user is then presented with several options:

311: The user may select a sub-attribute. In this situation, the display is updated as described in item #310, described above. Multiple levels of sub-attributes are supported in a like manner.

312: The user may select the move function. The results of this selection are described in FIG. 3.1, below.

313: The user may select the add child function. The results of this selection are described in FIG. 3.2, below.

314: The user may select the modify function. The results of this selection are described in FIG. 3.3, below.

315: The user may select the delete function. The results of this selection are described in FIG. 3.4, below.

316: The user may select the super folder checkbox function. The results of this selection are described in FIG. 3.5, below.

317: The user may select an attribute value. The results of this selection are described in FIG. 3.6, below.

Referring to FIG. 3.1, the Move Function of the Attribute Category Definition process is hereby described.

318: When the move function is selected, the user is prompted to select a new parent for the currently selected attribute category, attribute, or sub-attribute. At this point they will make such a selection.

319: At this point the user either selects the execute or cancel function.

320: If the execute function is selected, the database is updated, where the currently selected attribute category, attribute, or sub-attribute is moved to become part of the newly selected attribute category, attribute, or sub-attribute. The display is also updated to reflect the update, and the user is returned to the beginning of the category definition process, item 302, described above.

321: If the cancel function is executed, the user immediately returns to the first step of the move function, as described in 312, above.

Referring to FIG. 3.2, the Add Child Function of the Attribute Category Definition process is hereby described.

322: When the add child function is selected, the user is prompted to enter the name of the new child.

323: At this point the user either selects the execute or cancel function.

324: If the execute function is selected, the database is updated, where the new attribute category, attribute, or sub-attribute is added to become part of the currently selected attribute category, attribute, or sub-attribute. The display is also updated to reflect the update, and the user is returned to the beginning of the category definition process, item 302, described above.

325: If the cancel function is executed, the user returns to the first step of the add child function, as described in 313, above.

Referring to FIG. 3.3, the Modify Function of the Attribute Category Definition process is hereby described.

326: When the modify function is selected, the user is prompted to enter the new name of the currently selected attribute category, attribute, or sub-attribute.

327: At this point the user either selects the execute or cancel function.

328: If the execute function is selected, the database is updated, where the new name of the attribute category, attribute, or sub-attribute is added to replace the previous name of the currently selected attribute category, attribute, or sub-attribute. The display is also updated to reflect the update, and the user is returned to the beginning of the category definition process, item 302, described above.

329: If the cancel function is executed, the user is returned to the first step of the modify function, as described in 314, above.

Referring to FIG. 3.4, the Delete Function of the Attribute Category Definition process is hereby described.

315: When the delete function is selected, the system prepares to remove the currently selected attribute category, attribute, or sub-attribute.

330: At this point the user either selects the execute or cancel function.

331: If the execute function is selected, the database is updated, where the currently selected attribute category, attribute, or sub-attribute is removed. The display is also updated to reflect the update, and the user is returned to the beginning of the category definition process, item 302, described above.

332: If the cancel function is executed, the user is returned to the first step of the delete function, as described in 315, above.

Referring to FIG. 3.5, the Super Folder Checkbox Function of the Attribute Category Definition process is hereby described.

333: When the super folder checkbox is selected, the database is updated, where the currently selected attribute category, attribute, or sub-attribute is updated to reflect its new super folder status. The display is also updated to reflect the update, and the user is returned to the beginning of the category definition process, item 302, described above.

334: If the super folder checkbox is unselected, the database is updated, where the currently selected attribute category, attribute, or sub-attribute is updated to reflect its new non-super folder status. The display is also updated to reflect the update, and the user is returned to the beginning of the category definition process, item 302, described above.

Referring to FIG. 3.6, Attribute Value Definition within the Category Definition process is hereby described.

313: When an attribute value is selected, functionality described above for attribute categories, attributes, and sub-attributes is available as described above.

What is claimed is:

1. A method for performing a database query comprising:
requesting, from the data base, data base values for a first data category in response to a first selection by a user of the first data category;
selecting an attribute value from among the data base values for the first data category;
requesting, from the data base, data base values for a second data category in response to a second selection by a user of the second data category;
storing the first selection and the second selection in the database;
requesting, from the data base and in response to a user request, the stored first selection, the stored second selection and the data base values associated with the first selection and the second selection; and
continuing this process of requesting and storing until the desired level of query ‘drill down’ is completed.

2. A method for creating a data model comprising:
creating an attribute category in a database in response to a request by a user;
displaying a data model schema with information associated with the attribute category;
modifying the attribute category in the database in response to a request by the user;
displaying the data model schema with information associated with the modified attribute category;
moving the attribute category in the database to a new location within the data model in response to a request by the user;
displaying the data model schema with information associated with the moved attribute category;
deleting the attribute category in the database in response to a request by the user;
displaying the data model schema with information associated with the deleted attribute category;
creating an attribute super category in a database for aggregating attribute categories in response to a request by a user; and
displaying a data model schema with information associated with the attribute super category.

3. An apparatus for performing a database query, comprising:
a processing unit; and
a storage medium coupled to the processing unit, the storage medium storing program code implemented by the processing unit for executing the database query comprising:
requesting, from the data base, data base values for a first data category in response to a first selection by a user of the first data category;
selecting an attribute value from among the data base values for the first data category;
requesting, from the data base, data base values for a second data category in response to a second selection by a user of the second data category;
storing the first selection and the second selection in the database; and
requesting, from the data base and in response to a user request, the stored first selection, the stored second selection and the data base values associated with the first selection and the second selection.

4. An apparatus for performing data model creation, comprising:
a processing unit; and
a storage medium coupled to the processing unit, the storage medium storing program code implemented by the processing unit for executing creating the data model comprising:
creating an attribute category in a database in response to a request by a user;
displaying a data model schema with information associated with the attribute category;
modifying the attribute category in the database in response to a request by the user;
displaying the data model schema with information associated with the modified attribute category:
moving the attribute category in the database to a new location within the data model in response to a request by the user;
displaying the data model schema with information associated with the moved attribute category;
deleting the attribute category in the database in response to a request by the user; displaying the data model schema with information associated with the deleted attribute category;
creating an attribute super category in a database for aggregating attribute categories in response to a request by a user; and
displaying a data model schema with information associated with the attribute super category.
